(19) United States
(12) Patent Application Publication
(10) Pub. No.: US 2006/0041760 A1
(43) Pub. Date: Feb. 23, 2006

(54) Trusted computer activity monitoring and recording system and method

(76) Inventor: Zezhen Huang, Canton, MA (US)

Correspondence Address: Zezhen Huang, 5 Beaver Brook Road, Canton, MA, 02021, US

(21) Appl. No.: 10/180,705

(22) Filed: Jun. 26, 2002

(51) Int. Cl. G06F 12/14

(52) U.S. Cl. 713/189

(57) ABSTRACT

A trusted computer activity monitoring and recording system and method provides trust between the computer or the computer user which activities are being recorded and the supervisor who governs the monitoring and recording system by using a digital certificate comprising a plurality of policies and the public key of the supervisor. Computer activities are recorded and actions are performed according to the policies comprised in the certificate, and recorded data are encrypted using the public key comprised in the certificate. Recorded data may be further signed by digital signatures created with the private key of the computer or the computer user.

### FIELD OF INVENTION

The present invention generally relates to the field of computer software and hardware. More specifically, the present invention relates to computer activity monitoring and recording systems and methods implemented in software and hardware.

### INTRODUCTION

Computer monitoring and recording software runs in a computer to monitor and record computer activities in real-time. The software may record user key strokes, mouse clicks and movements, program communications, network communications, file access, database access, computer resource usage, emails sent and received, websites visited, screen snapshots, etc. The recorded data may be sent over network to another computer in real-time or saved in files and be processed by other software. In some applications, the monitoring and recording software may operate secretly without the awareness of the user and is often referred to as spy software. Such software allows employers to track their employees' productivity closely, parents to monitor their children's Internet activities, companies to monitor activities of computers, servers, and gateways in their networks.

The conventional monitoring and recording software however has following drawbacks that prevent it from widely deployed in workspace:
1. When it is applied to monitor employee activities, it violates employee privacy and trust. Employees may not be certain who deploys and controls the software, what data have been recorded and who can process or view the recorded data. Even if the employer may have published policies dictating the scope and rules of monitoring and recording, there is no trusted means to enforce the policies and employees cannot be certain that recorded data will not be abused by anyone.
2. The employer cannot ensure the fidelity of the recorded data. Skilled employees or third party software may tamper the recorded data including deletion, addition, or replacement of the data, or may prevent some data from being recorded in the first place.
3. Recorded data may be stolen or intercepted by third party for malicious purpose.

### SUMMARY OF THE INVENTION

This invention is a system and method for computer monitoring and recording that overcomes the aforementioned drawbacks of the conventional monitoring and recording software. The system and method ensures the trust of the computer users or computers which activities are being recorded and the supervisors who control the monitoring and recording by incorporating digital certificate and public key cryptography technologies.

Public key cryptography and digital certificate technologies are well-known prior arts that can be found in publications. Public key cryptography involves a pair of keys, a public key and a private key, associated with an entity. Data encrypted with the public key can be decrypted only with the private key. And vice versa, data encrypted with the private key can be decrypted only with the public key. A digital certificate is an electronic document that has been digitally signed by a trusted Certificate Authority (CA). A digital certificate may comprise identity of an individual or a company or any entity bounded to the certificate, a public key, other information associated with the entity, and a digital signature signed by the trusted CA. The digital signature signed by the trusted CA ensures that the identity is authenticated and that the fidelity of the certificate can be verified. The digital signature is generated by first running a one-way hash function on the electronic document to generate a data sequence and then encrypting the data sequence using a private key held by the CA. The one-way hash function has the unique feature that two different electronic documents will generate two different data sequences when passing through the same hash function. Therefore it ensures that any alternation in the electronic document will result in different data sequences. The data sequence is further encrypted using a private key held by the CA to generate the digital signature. The paired public key of the CA is made available publicly, usually in another digital certificate bounded to the identity of the CA. Only the paired public key can successfully decrypt the signature, which in turn proves that the signature has been encrypted (that is, signed) by the CA. Anyone with the public key of the CA can verify the fidelity of the digital certificate by first running the electronic document comprised in the certificate through the same hash function to generate a data sequence, and then comparing the generated data sequence with the decrypted signature. If the two are the same, it is proven that the certificate has been signed by the CA and that the certificate has not been tampered. Digital certificates have been widely used by web servers to publish a public key and bound the public key to the identity of the web server. When a web browser receives a digital certificate from a web server, it verifies the fidelity of the certificate. If the certificate is accepted, the web browser then uses the public key comprised in the certificate to encrypt data sent to the web server. Only the web server can decrypt the data because only the web server has the paired private key.

In the present invention, the computer monitoring and recording system comprises two computer programs: a recording program and a processing program. The recording program runs on a computer to execute functions including recording computer activities. The processing program is used to process or display the data recorded by the recording program.

In accordance with the present invention, a digital certificate referred to as policy certificate is first created by a controlling entity and signed by a trusted CA. The controlling entity is the supervisor governing the computer monitoring and recording system and could be an individual, a company, or any entity. The policy certificate comprises the identity of the controlling entity, a public key, and a plurality of policies. The certificate is signed by a trusted CA, which may be the controlling entity itself or other public trusted entity. The public key comprised in the policy certificate is paired with a private key held secretly by the controlling entity. The policies comprised in the certificate among others specify what computer activities are to be monitored and recorded. A policy may specify a plurality of actions for a plurality of computer entities. For example, a policy may specify recording keystrokes on a computer program, another policy may specify recording keystrokes and file accesses associated with another computer program, and another policy may specify recording network communication activities of all computer programs. Policies may also be absent in the certificate to identify a default set of polices that is known a priori by the recording program. The policy certificate is loaded into the recording program. The recording program first verifies that the CA signing the certificate can be trusted and that the certificate has not been tampered. The recording program may display the content of the policy certificate comprising the identity of the controlling entity and the recording policies and prompt for the computer user for acceptance or rejection. In other applications, the recording program may check with a database comprising a plurality of acceptable controlling entities and automatically accept or reject the policy certificate depending on whether the controlling entity of the certificate is comprised in the database or not. Upon acceptance of the policy certificate, the recording program then performs functions including recording of computer activities according to the policies comprised in the policy certificate, and encrypts the recorded data using the public key comprised in the policy certificate. The encrypted data is sent to the processing program and is decrypted with the private key held by the controlling entity. The decrypted data can then be processed or displayed by the processing program. The decryption process can be performed by a separate program or be integrated with the processing program.

Since the policy certificate is authenticated by a trusted CA, the computer user or the computer which activities are being recorded can be certain who has really created the policies and that the recording will be limited to the scope specified by the policies, as the recording program will enforce the policies. The computer user or the computer and the controlling entity can be certain that the recorded data cannot be used for malicious purpose because no one else other than the controlling entity holding the private key can decrypt the data. And the controlling entity can be certain that the recorded data cannot be tampered by anyone without the private key. Therefore, the system and method disclosed in this invention provides mutual trust between the computer users or computers and the controlling entity.

The computer user or computer may further certify the recorded data by digitally signing the recorded data. The signature for the recorded data can be generated before or after encryption of the recorded data. The signature is encrypted using a private key held by the computer user or the computer. And the paired public key is made publicly available, preferably by a digital certificate referred to as user certificate that comprises the identity of the computer user or the computer and the public key. The user certificate bounds the public key to the identity of the computer user or the computer. With the user public key, the controlling entity can verify the user signature associated with the recorded data using conventional signature verification technology, and therefore, can be certain that the data has originated from the specified computer user or the computer.

In the present invention, the policy certificate may further comprise identities of a plurality of controlled entities. A controlled entity refers to a computer user or a computer or any combination for which the policies comprised in the policy certificate can be applied. The recording program can check the identities of the local computer and computer user and reject the certificate if said identities are not comprised in the identities of controlled entities comprised in the policy certificate. For example, the identities of controlled entities may comprise a list of user names for which the recording policies will apply, and if the local computer user name is not in the list, the recording program will reject the policy certificate.

In the present invention, the encrypted data can be sent to the processing program in real-time over a computer network or saved in files in any storage medium that can be retrieved by the processing program.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1A is a diagram of the recording program in accordance with one embodiment of the present invention;

FIG. 1B is a diagram of the processing program in accordance with one embodiment of the present invention;

FIG. 2 is a diagram depicting a policy certificate used for the recording program of FIG. 1A;

FIG. 3 is a diagram depicting examples of five policies;

FIG. 4 is a diagram depicting the processing flowchart of the recording program of FIG. 1A;

FIG. 5 is a diagram depicting the encrypted data stream generated by the recording program of FIG. 1A;

FIG. 6 is a diagram depicting the processing flowchart of the processing program of FIG. 1B;

FIG. 7A is a diagram of the recording program comprising the user signature generation module in accordance with another embodiment of the present invention;

FIG. 7B is a diagram of the processing program comprising the user signature verification module in accordance with another embodiment of the present invention;

FIG. 8A is a diagram depicting the processing flowchart of the user signature generation module of FIG. 7A;

FIG. 8B is a diagram depicting the processing flowchart of the user signature verification module of FIG. 7B.

For the most part, and as will be apparent when referring to the figures, when an item is used unchanged in more than one figure, it is identified by the same alphanumeric reference indicator in the various figures in which it is presented.

### DETAILED DESCRIPTION OF THE PREFERRED EMBODIMENT

This invention is a system and method for trust computer monitoring and recording. The system and method provide trust between computer users or computers referring to as the controlled entities whose activities are being monitored and recorded and the supervisor referring to as the controlling entity who supervises the computer users or the computers. The system and method ensure the controlled entities that the recording policies are created by said controlling entity and the recording scope is limited to the specified recording policies, and the recorded data cannot be viewed or processed by anyone other than the controlling entity. The system and method ensure the controlling entity that the recorded data cannot be tampered and it is recorded for said controlled entity.

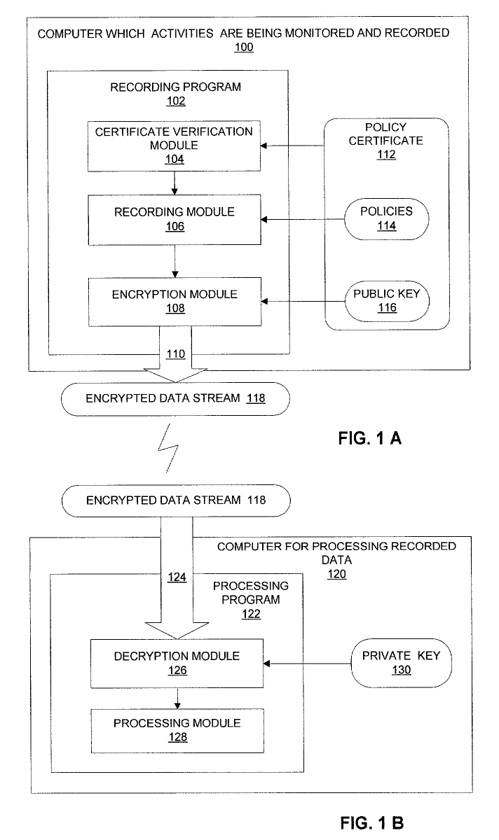

In one preferred embodiment as shown in FIG. 1A and FIG. 1B, the computer monitoring and recording system comprises two computer programs, a recording program 102 of FIG. 1A and a processing program 122 of FIG. 1B. The recording program 102 runs in a computer 100 which activities are being monitored and recorded. The processing program 122 runs in a computer 120 used by the controlling entity to process and/or display the recorded data. With reference to FIG. 1A, the recording program 102 is implemented as a group of modules: a certificate verification module 104, a recording module 106, and an encryption module 108. With reference to FIG. 1B, the processing program 122 is implemented as a group of modules: a decryption module 126, and a processing module 128. The modules comprised in the recording program 102 and processing program 122 may be implemented in software, firmware, hardware, or some combination thereof.

With reference to FIG. 1A, the encryption module 108 of FIG. 1A generates encrypted data stream 118. The encrypted data stream 118 is sent to the output connector 110 of the recording program 102 of FIG. 1A for transmission and is received by the input connector 124 of the processing program 122 of FIG. 1B. The data transmission may be over a computer network in real-time wherein the output connector 110 and the input connector 124 are interface to the computer network. The data transmission may also be carried out by files saved in any storage medium wherein the output connector 110 and the input connector 124 are interface to the storage medium.

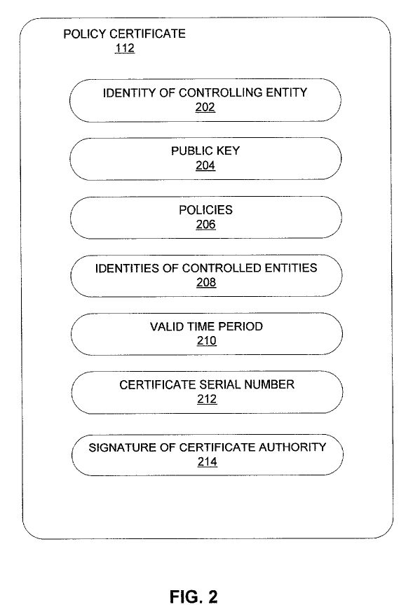

In accordance to the present invention, a digital certificate referred to as policy certificate is first created using digital certificate technologies. Detailed description about digital certificate technologies can be found in prior art publications. With reference to FIG. 1A, a policy certificate 112 is loaded into a memory buffer in the computer 100 and retrieved by the recording program 102. The policy certificate 112 is verified by the certificate verification module 104 for acceptance or rejection. The policy certificate 112 comprises a plurality of policies that specify the actions and scopes of recording carried out by the recording module 106 of the recording program 102. The policy certificate 112 also comprises a public key used by the encryption module 108 for encrypting the recorded data. Preferably as shown in FIG. 2, the policy certificate 112 comprises the following elements:
a) identity of controlling entity 202;
b) public key 204;
c) a plurality of policies 206;
d) identities of controlled entities 208;
e) valid time period 210;
f) certificate serial number 212;
g) signature of Certificate Authority 214.
   Wherein, the identity of controlling entity 202 refers to a supervisor that may be an individual, a company, or any entity that controls and manages the computer monitoring and recording system; the public key 204 is used for data encryption; the policies 206 specify the actions and scopes of recording; the identities of controlled entities 208 refer to identities of a plurality of computers, or computer users, or any combination for which the policies 206 can be applied; the valid time period 210 specifies the time period the policy certificate 112 is valid; the certificate serial number 212 is a unique number for identifying the policy certificate 112; the signature of Certificate Authority 214 is the digital signature signed by the Certificate Authority on the certificate 112. The Certificate Authority is a trusted Authority that has verified the identity of controlling entity 202 and related information comprised in the policy certificate 112. The signature of Certificate Authority 214 allows third-party software to verify the fidelity of the policy certificate 112, including authenticity of the controlling entity.

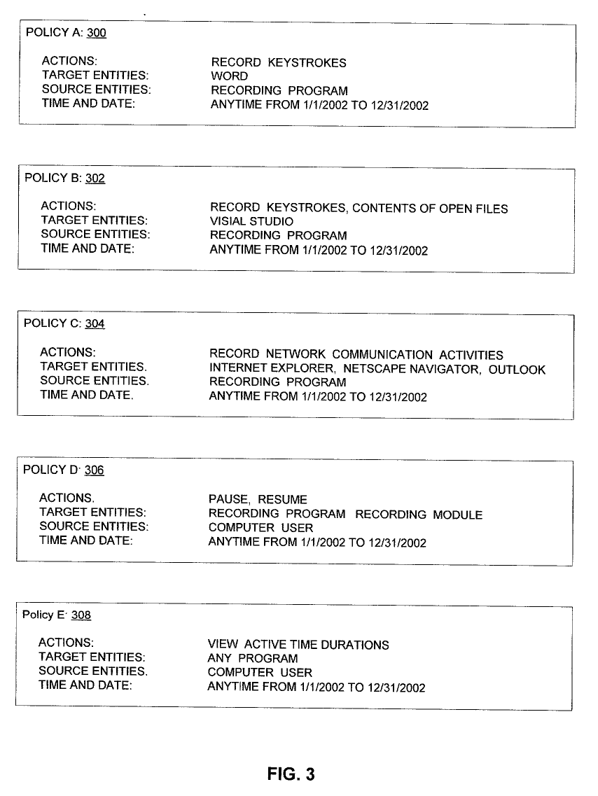

The policies 206 comprised in the policy certificate 112 specify what computer activities are to be recorded and other actions that may be carried out by the recording program or the computer user. A policy may specify a plurality of actions on a plurality of computer entities, or a plurality of actions allowed for the computer user. FIG. 3 depicts examples of five policies. Policy A 300 specifies recording keystrokes on computer program named “Word”; policy B 302 specifies recording keystrokes and contents of all open files associated with computer program named “Visual Studio”; policy C 304 specifies recording network communication activities on three programs “Internet Explorer”, “Netscape Navigator”, and “Outlook”; policy D 306 specifies that the computer user can pause and resume the recording module at anytime; and policy E 306 specifies that the computer user is allowed to view the time durations of any active programs. The policies 206 of FIG. 2 may also comprise a plurality of computer executable codes to carry out the intended actions. For example, the policies 206 may contain a Java applet to execute the actions, wherein the recording program 102 of FIG. 1A comprises a Java engine (not shown in FIG. 1A) to execute the Java applet. Policies may also be absent in a policy certificate to identify a default set of polices that is known a priori by the recording program.

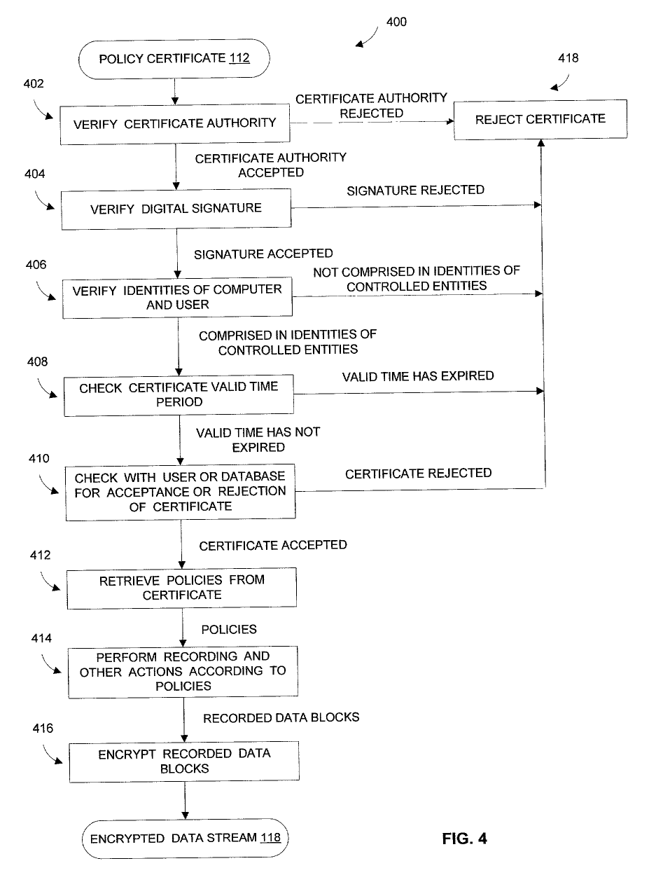

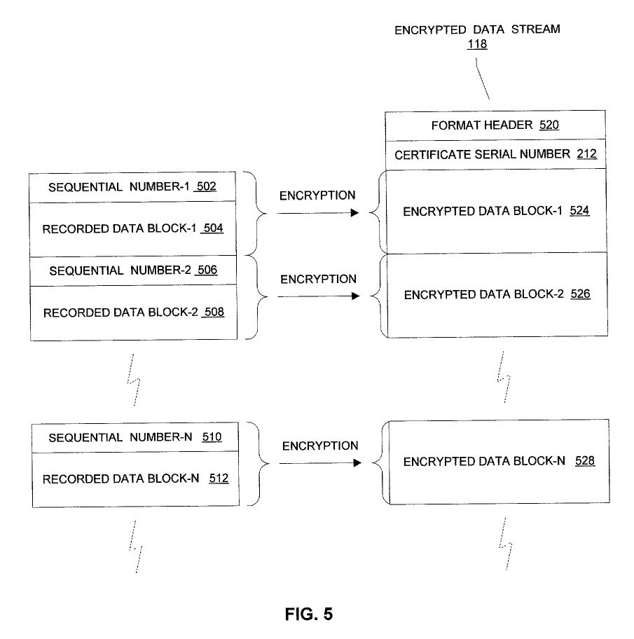

Preferably, the modules comprised in the recording program 102 of FIG. 1A implement the method depicted in flowchart 400 of FIG. 4. With reference to FIG. 4, in step 402, the Certificate Authority comprised in the policy certificate 112 is verified for its trustworthiness and the certificate 112 is rejected in step 418 if the Certificate Authority is rejected. In step 404, the digital signature comprised in the certificate 112 is verified for truthfulness with the certificate 112 and the certificate 112 is rejected in step 418 if the signature is rejected. In step 406, the computer and computer user identities are checked and the certificate 112 is rejected in step 418 if said identities are not comprised in the identities of the controlled entities comprised in the certificate 112. In step 408, the valid time period of the certificate 112 is checked and the certificate 112 is rejected in step 418 if the valid time has expired. In step 410, the computer user or database is checked to accept or reject the certificate 112. When checking with the computer user, the content of the certificate 112 may be displayed (not shown in FIG. 4) to the computer user and the computer user is allowed to accept or reject the certificate 112. When checking with database, the certificate 112 may be accepted or rejected according to rules set up in the database (not shown in FIG. 4), for example, the certificate 112 may be accepted if the identity of the controlling entity comprised in the certificate 112 is comprised in the database that comprises a list of acceptable identities of controlling entities. After the certificate 112 has been accepted, the policies are retrieved from the certificate 112 in step 412; and activity recording and other actions are performed according to the policies, in step 414. The recording in step 414 generates a sequence of recorded data blocks. In step 416, each recorded data block is then encrypted using the public key comprised in the certificate 112. The encryption method used in step 416 could be any well-known public key encryption method. The encryption in step 416 generates the encrypted data stream 118 comprising the encrypted data blocks. The encrypted data stream 118 is passed through the output connector 110 as shown in FIG. 1A.

Preferably, the encrypted data stream 118 generated by encryption module 108 of FIG. 1A and in step 416 of FIG. 4 is of the format as shown in FIG. 5. With reference to FIG. 5, the first data block of the encrypted data stream 118 is the format header 520 that comprises format information about the encrypted data stream 118. The second data block is the policy certificate serial number 212 that uniquely identifies the policy certificate 112 of FIG. 2. The subsequent data blocks are encrypted data blocks 524, 526, 528. Each encrypted data block comprises a sequential number and a recorded data block. As shown in FIG. 5, encrypted data block 524 comprises sequential number 502 and recorded data block 504. The sequential numbers (502, 506, 510) are incremental numbers that allows the processing program 122 of FIG. 1B to detect any missing recorded data blocks.

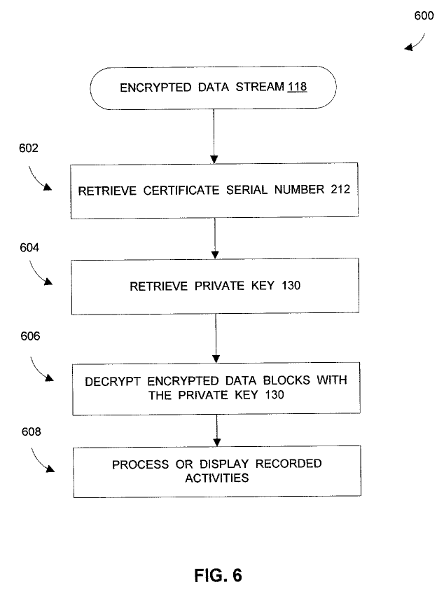

The encrypted data stream 118 is sent to the processing program 122 through the input connector 124, as shown in FIG. 1B. Preferably, the modules comprised in the processing program 122 of FIG. 1B implement the method depicted in flowchart 600 of FIG. 6. With reference to FIG. 6, the certificate serial number 212 of FIG. 5 is retrieved from the encrypted data stream 118 in step 602. The serial number 212 uniquely identifies the policy certificate 112 that is uniquely associated with the private key 130 used for decrypting the encrypted data stream 118 as shown in FIG. 1B. The private key 130 is retrieved in step 604. And the encrypted data blocks 524, 526, 528 of FIG. 5 are decrypted using the private key 130 in step 606. In step 608, computer activities comprised in the decrypted data blocks are processed or displayed in any means desirable for human interaction.

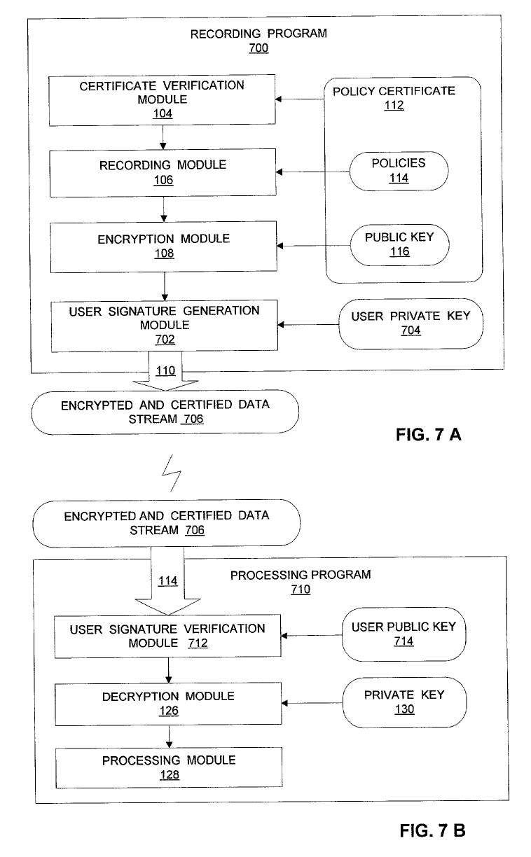

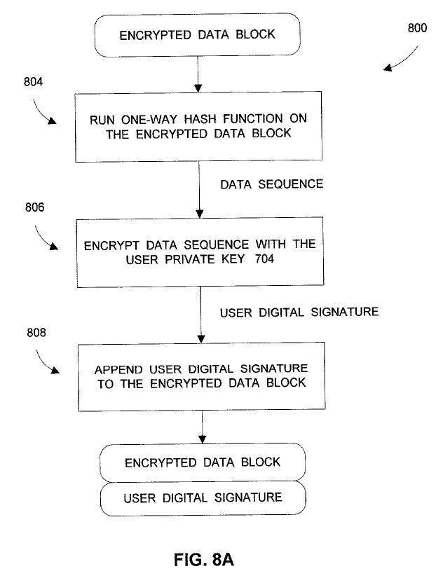

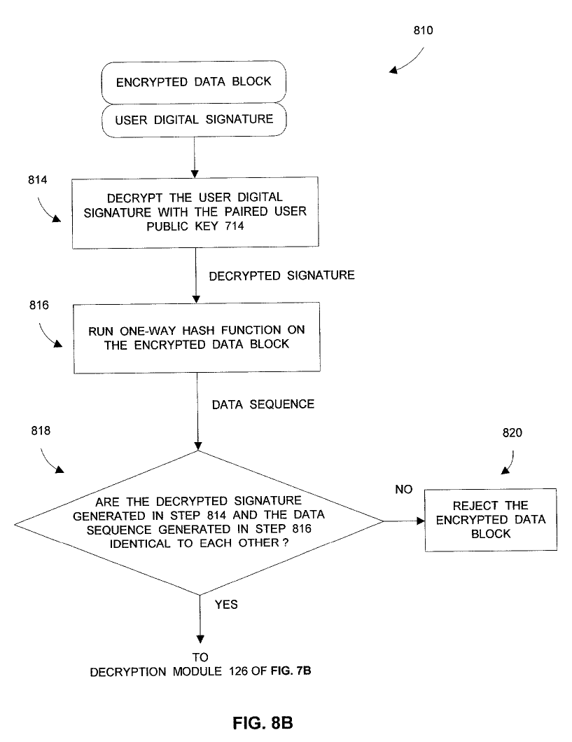

In another preferred embodiment, the recorded data is certified by adding a digital signature of the computer user. In this preferred embodiment as shown in FIG. 7A and FIG. 7B, a user signature generation module 702 is added to the recording program 700 of FIG. 7A, and a user signature verification module 712 is added to the processing program 710 of FIG. 7B. The other modules in FIG. 7A and FIG. 7B, that is, the certificate verification module 104, the recording module 106, the encryption module 108, the decryption module 126, and the processing module 128 are the same as those with the same module numbers in FIG. 1A and FIG. 1B.

Preferably, the user signature generation module 702 of FIG. 7A implements the method depicted in flowchart 800 of FIG. 8A. With reference to FIG. 8A, a user signature is generated for each encrypted data block by first running a one-way hash function on the encrypted data block to generate a data sequence in step 804, then encrypting the data sequence using the private key 704 of the computer or the computer user in step 806, wherein the encrypted data sequence is the user signature that can only be decrypted using the public key 714 paired with the private key 704. In step 808, the user digital signature is appended to the encrypted data block.

The user signature verification module 712 of FIG. 7B verifies every user signature associated with each encrypted data block. Preferably, the user signature verification module 712 implements the method depicted in flowchart 810 of FIG. 8B. With reference to FIG. 8B, for each pair of encrypted data block and user digital signature, in step 814, the user digital signature is decrypted using the public key 714 paired with the private key 704 used in step 806 of FIG. 7A; in step 816, the same one-way hash function that is used in step 804 of FIG. 8A is run on the encrypted data block to generate a data sequence; then the generated data sequence is compared with the decrypted user signature in step 818. If the generated data sequence is identical to the decrypted user signature, it is proved that the encrypted data block has been signed by the computer user or the computer and is passed to the decryption module 126 of FIG. 7B for further processing. If the generated data sequence differs from the decrypted user signature in step 818, the encrypted data block has not been signed by the computer user or has been tampered and therefore is rejected, in step 820. The public key used in step 814 of FIG. 8B can be obtained by any means. Preferably, the public key is embedded in a digital certificate referred to as user certificate that has been issued by a trusted Certificate Authority. The user certificate bounds the public key to the identity of the computer or the computer user or both. The hash function used for generating the data sequence on the encrypted data block in step 804 of FIG. 8A and step 816 of FIG. 8B could be any hash function commonly used for generating digital signature.

Adding digital signatures to encrypted data blocks ensures the controlling entity that the data blocks are originated from the specified computer or computer user.

The invention may be embodied in other specific forms without departing from the spirit or central characteristics thereof. The present embodiments are therefore to be considered in all respects as illustrative and not restrictive, the scope of the invention being indicated by appending claims rather than by the foregoing description, and all changes that come within the meaning and range of equivalency of the claims are therefore intended to be embraced therein.

What is claimed is:

1. A method of recording activities at a computer having a digital certificate comprising a plurality of policies, said method comprising:
A. verifying said digital certificate;
B. performing a plurality of actions comprising recording activities at said computer, wherein said plurality of actions are specified in said plurality of policies.

2. The method of claim 1, wherein said digital certificate comprises a public key, said method further comprising:
C. generating a plurality of recorded data blocks comprising said activities;
D. encrypting said plurality of recorded data blocks into a data stream comprising a plurality of encrypted data blocks using said public key, wherein said plurality of encrypted data blocks are decrypted at another computer using a private key paired with said public key.

3. The method of claim 2, wherein said digital certificate comprises a serial number and said data stream comprises said serial number, said serial number being used at said another computer to identify said private key for decryption.

4. The method of claim 2, wherein each of said plurality of recorded data blocks comprises a sequential number, said sequential number being used to detect missing of any of said plurality of recorded data blocks at said another computer.

5. The method of claim 2, wherein said data stream is sent to said another computer in any of a plurality of means comprising:
1) sending over a computer network;
2) sending over a communication network;
3) sending over a storage medium.

6. The method of claim 2, wherein said computer has a private key of a user, said method further comprising:
E. generating a plurality of digital signatures for said plurality of encrypted data blocks using said private key, wherein said plurality of digital signatures and said plurality of encrypted data blocks are verified at said another computer using a public key of said user paired with said private key.

7. The method of claim 1, wherein said computer has a private key of a user, said method further comprising:
B. generating a plurality of recorded data blocks comprising said activities;
C. generating a plurality of digital signatures for said plurality of recorded data blocks using said private key, wherein said plurality of digital signatures and said plurality of recorded data blocks are verified at another computer using a public key of said user paired with said private key.

8. The method of claim 7, wherein said public key is comprised in a digital user certificate, wherein said digital user certificate further comprises identity of said user.

9. The method of claim 1, wherein said digital certificate comprises a digital signature and said verifying a digital certificate in step A further comprises verifying said digital signature.

10. The method of claim 1, further comprising:
C. checking with a user or a database for acceptance or rejection of said digital certificate.

11. The method of claim 1, wherein said plurality of actions are chosen from a group comprising:
1) recording key strokes;
2) recording mouse clicks and movements;
3) recording files access;
4) recording database access;
5) recording program active durations;
6) recording network communications;
7) recording telephone communications;
8) recording sound input and output;
9) recording video input and output;
10) recording web sites visited;
11) recording messages;
12) recording emails;
13) recording images;
14) recording screen snapshots;
15) recording computer resource usage;
16) recording program attributes;
17) setting program attributes;
18) setting program configurations;
19) setting system registry;
20) opening files;
21) sending messages;
22) receiving messages;
23) displaying messages.

12. The method of claim 1, wherein said plurality of policies comprise a plurality of computer executable codes to perform at least one of said plurality of actions, wherein said performing in step B comprises executing said plurality of computer executable codes, wherein said plurality of computer executable codes are written with any of program languages comprising:
1) Java language;
2) Pearl language;
3) Tcl language;
4) Visual basic language;
5) ActiveX control language;
6) COM language;
7) NET language;
8) C# language;
9) C/C++ language;
10) any machine executable scripting language.

13. The method of claim 1, wherein said computer is any of a group of computing devices comprising:
1) personal computer;
2) server;
3) gateway;
4) network router;
5) network switch;
6) personal digital assistant;
7) communication device;
8) client terminal.

14. The method of claim 1, wherein said digital certificate comprises a plurality of identities of controlled entities and said controlled entities comprises a plurality of computers and a plurality of users, said method further comprising:
C. checking identity of said computer and identity of user of said computer;
D. rejecting said digital certificate if said identity of said computer and said identity of said user are not comprised in said plurality of identities of controlled entities.

15. The method of claim 1, wherein said digital certificate comprises a valid time period, said method further comprising:
C. checking current time with said valid time;
D. rejecting said digital certificate if said valid time period has expired.

16. The method of claim 1, wherein said plurality of actions in step B comprise a plurality of operations in response to a plurality of user requests at said computer, said plurality of operations are chosen from a group comprising:
1) pausing said recording activities in step B;
2) resuming said recording activities in step B;
3) displaying portions of said activities recorded in step B;
4) modifying portions of said plurality of policies used in said recording activities in step B.

17. A computer activity recording system having a recording program running at a computer and a processing program running at another computer, said system comprising:
A. said recording program having a digital certificate comprising a plurality of policies, said recording program comprising:
1) a certificate verification module, configured to verify and accept or reject said digital certificate;
2) a recording module, configured to perform a plurality of actions comprising recording activities and to generate a plurality of recorded data blocks comprising said activities, said plurality of actions being specified in said plurality of policies;
B. said processing program comprising:
1) a processing module, configured to process said activities comprised in said plurality of recorded data blocks.

18. The system of claim 17, wherein said digital certificate comprises a public key, said recording program further comprising:
3) an encryption module, configured to encrypt said plurality of recorded data blocks into a data stream comprising a plurality of encrypted data blocks using said public key; and
said processing program further comprising:
2) a decryption module, configured to decrypt said plurality of encrypted data blocks using a private key paired with said public key to recover said plurality of recorded data blocks.

19. The system of claim 18, wherein said plurality of policies comprised in said digital certificate is null, wherein said plurality of actions are specified in a preloaded set of policies comprised in said recording module.

20. The system of claim 18, wherein said data stream is sent to said processing program in any of a plurality of means comprising:
i. sending over a computer network;
ii. sending over a communication network;
iii. sending over a storage medium.

21. The system of claim 17, wherein said digital certificate comprises a digital signature and said certificate verification module comprises:
i. a signature verification module, configured to verify said digital signature.

22. The system of claim 17, said recording program further comprising:
3) a certificate acceptance module, configured to check with a user or database for acceptance or rejection of said digital certificate.

23. The system of claim 17, wherein said plurality of actions are chosen from a group comprising:
1) recording key strokes;
2) recording mouse clicks and movements;
3) recording files access;
4) recording database access;
5) recording program active durations;
6) recording network communications;
7) recording telephone communications;
8) recording sound input and output;
9) recording video input and output;
10) recording web sites visited;
11) recording messages;
12) recording emails;
13) recording images;
14) recording screen snapshots;
15) recording computer resource usage;
16) recording program attributes;
17) setting program attributes;
18) setting program configurations;
19) setting system registry;
20) opening files;
21) sending messages;
22) receiving messages;
23) displaying messages.

24. The system of claim 17, wherein said plurality of policies comprise a plurality of computer executable codes to perform at least one of said plurality of actions, said recording program further comprising:
3) a code executing module, configured to execute said plurality of computer executable codes, said plurality of computer executable codes being written with any of program languages comprising:
i. Java language;
ii. Pearl language;
iii. Tcl language;
iv. Visual basic language;
v. ActiveX control language;
vi. COM language;
vii. NET language;
viii. C# language;
ix. C/C++ language;
x. any machine executable scripting language.

25. The system of claim 17, wherein said computer and said another computer are any of a group of computing devices comprising:
1) personal computer;
2) server;
3) gateway;
4) network router;
5) network switch;
6) personal digital assistant;
7) communication device;
8) client terminal.

26. The system of claim 17, wherein said digital certificate comprises a plurality of identities of controlled entities and said controlled entities comprise a plurality of computers and a plurality of users, wherein said certificate verification module comprises:
i. an identity verification module, configured to check identity of said computer and identity of user of said computer and reject said digital certificate if said identity of said computer and said identity of said user are not comprised in said plurality of identities of controlled entities.

27. The system of claim 17, wherein said computer has a private key of a user, said recording program further comprising:
3) a user signature generation module, configured to generate a plurality of digital signatures for said plurality of recorded data blocks using said private key; and
said processing program further comprising:
2) a user signature verification module, configured to verify said plurality of digital signatures and said plurality of recorded data blocks using a public key of said user paired with said private key.

28. The system of claim 17, wherein said plurality of actions comprise a plurality of operations in response to a plurality of user requests at said computer, said recording program further comprising:
3) a user action module, configured to accept said plurality of user requests to perform said plurality of operations, said plurality of operations comprising:
i. pausing said recording module;
ii. resuming said recording module;
iii. displaying portions of said plurality of recorded data blocks generated by said recording module;
iv. modifying portions of said plurality of policies used in said recording module.
